(19) United States
(12) Patent Application Publication
(10) Pub. No.: US 2023/0233027 A1
(43) Pub. Date: Jul. 27, 2023

(54) WIRELESS TEMPERATURE CONTROL TURKEY FRYER

(71) Applicant: NINGBO ZHAOFENG COOKER UNITS CO., LTD., NINGBO (CN)

(72) Inventor: Zhaowei LI, Ningbo City (CN)

(21) Appl. No.: 17/976,900

(22) Filed: Oct. 31, 2022

(30) Foreign Application Priority Data
Jan. 24, 2022 (CN) 202220194016.0

(51) Int. Cl. A47J 37/12; F24C 3/12

(52) U.S. Cl. CPC A47J 37/1266; F24C 3/126; F24C 3/124; A47J 37/1204; A47J 37/1276; A47J 37/1242

(57) ABSTRACT

The present invention provides wireless temperature control turkey fryer which relates to the field of cooking apparatus technologies; the main technical scheme comprises a fryer body, a fryer lid matching the fryer body and an outer ring seat supporting the fryer body. A stove body for heating the bottom of the fryer body is disposed inside the outer ring seat. The stove body is provided with a gas disconnecting piece for cutting off a gas passage. The fryer lid is provided with an electronic thermometer. The electronic thermometer is provided with a temperature insertion pin for being inserted into the fryer body for temperature monitoring. The temperature insertion pin is in communication connection with the gas disconnecting piece such that the gas disconnecting piece is enabled to start and cut off the gas passage when a temperature in the fryer body exceeds a set threshold, achieving convenient temperature control effect.

### CROSS REFERENCE TO THE RELATED APPLICATIONS

This application is based upon and claims priority to Chinese Patent Application No. 202220194016.0, filed on Jan. 24, 2022, the entire contents of which are incorporated herein by reference.

### TECHNICAL FIELD

The present invention relates to the field of cooking apparatus technologies, and in particular to a wireless temperature control turkey fryer.

### BACKGROUND

For American people, turkey is not only a kind of delicious food but also a spiritual symbol. On Thanksgiving Day, each family will prepare and eat turkeys. Therefore, turkey cooking apparatuses are very popular among American families. The existing turkey cooking apparatus usually comprises a seat and a turkey fryer mounted above the seat. The seat is provided with a stove which is connected with an external gas supply device. The above turkey cooking apparatus can basically satisfy a cooking process of a turkey, but it lacks a temperature control device. When a cooking oil in the turkey fryer has an excessively high temperature, the cooking oil may generate harmful substances which may cling to the turkey and thus threaten the health of the eaters. In addition, the high oil temperature may also affect the taste of the turkey. Furthermore, as the oil temperature increases continuously, the heated oil in the turkey fryer may burn and may even cause a safety accident.

A Chinese patent with a publication number CN209474435U discloses a turkey cooking apparatus, comprising a seat, a stove and a turkey fryer, where the stove and the turkey fryer are disposed respectively on the seat, and the stove is located below the turkey fryer and connected with an external gas supply device. Further, the turkey cooking apparatus comprises a temperature control device disposed on the seat or the stove and a safety valve disposed on the stove. The temperature control device comprises a temperature controller. The temperature controller is abutted against an outer circumferential wall of the turkey fryer. The temperature controller is electrically connected with the safety valve so that the stove can be turned on and off by the safety valve.

However, the turkey cooking apparatus can realize effective temperature control only when the temperature controller is controlled to be cooperatively abutted against the turkey fryer. In this case, temperature control effectiveness and use conveniences will be affected and thus need to be improved.

### SUMMARY

In order to address the shortcomings of the prior arts, the present invention provides a wireless temperature control turkey fryer, which has the effects of use convenience and significantly-increased temperature control effectiveness.

In order to achieve the above purposes, the present invention adopts the following technical solution.

The present disclosure provides a wireless temperature control turkey fryer, comprising a fryer body, a fryer lid matching the fryer body and an outer ring seat supporting the fryer body. A stove body for heating the bottom of the fryer body is disposed inside the outer ring seat. The stove body is provided with a gas disconnecting piece for cutting off a gas passage. The fryer lid is provided with an electronic thermometer. The electronic thermometer is provided with a temperature insertion pin for being inserted into the fryer body for temperature monitoring. The temperature insertion pin is in communication connection with the gas disconnecting piece such that the gas disconnecting piece is enabled to start and cut off the gas passage when a temperature in the fryer body exceeds a set threshold.

By using the above technical solution, the stove body inside the outer ring seat can heat the bottom of the fryer body for cooking, and further, when the fryer lid and the fryer body are cooperatively fixed, the electronic thermometer fixed on the fryer lid can perform temperature monitoring by the temperature insertion pin directly inserted into the fryer body, bringing use conveniences and increased temperature control effectiveness; at the same time, when the temperature in the fryer body exceeds the set threshold, the gas disconnecting piece can be enabled to start and cut off the gas passage, achieving temperature control effect.

The present invention is further configured as follows: the electronic thermometer is provided with a buzzer for giving warning at the time of the temperature in the fryer body exceeding the set threshold.

By using the above technical solution, the buzzer can give effective warning in time to help a user to realize effective cooking for food materials, thus significantly improving the use convenience of the wireless temperature control turkey fryer.

The present invention is further configured as follows: a plurality of support legs distributed in a same radian on an outer circumferential side of the outer ring seat, a plurality of U-shaped stove rack sheet metal pieces distributed in a same radian on an inner side of the outer ring seat, both ends of the stove rack sheet metal piece are fixedly connected to the outer ring seat, and the bottom of the fryer body is abutted against the stove rack sheet metal pieces.

In the above technical solution, the stove rack sheet metal pieces can effectively support and fix the fryer body so as to achieve the effect of placing the fryer body easily; the support legs can stably support the outer ring seat so as to achieve the purpose of stable cooking.

The present invention is further configured as follows: the gas disconnecting piece comprises a control panel which is provided with a gas disconnecting assembly in communication connection with the electronic thermometer and a needle valve in communication with the stove body.

In the above technical solution, when the gas disconnecting assembly receives a real-time monitored temperature of the electronic thermometer, the gas passage of the stove body can be cut off by controlling the needle valve to be off, thus realizing temperature control. In this way, the wireless temperature control turkey fryer has the effects of use conveniences and significantly-increased temperature control effectiveness.

The present invention is further configured as follows: an annular wind barrier is fixedly mounted at inner sides of the plurality of stove rack sheet metal pieces, the stove body is provided with a stove for producing combustion flame, the annular wind barrier is disposed on the stove, and through holes are disposed on both of the annular wind barrier and the outer ring seat.

In the above technical solution, the annular wind barrier can effectively keep out wind and prevent environmental influence, and the through holes are used for the gas to carry oxygen into the stove so as to realize stable gas combustion effect.

The present invention is further configured as follows: the stove is provided with a lifting bolt inserted from top down and the lifting bolt is thread-connected with a heat insulation sheet located at a lower end of the stove.

In the above technical solution, the heat insulation sheet can perform bottom heat insulation and can be adjusted by rotation for a distance between the heat insulation sheet and the stove so as to reduce the operation difficulty and improve use convenience.

In conclusion, the present invention has the following beneficial effects: the electronic thermometer is disposed on the fryer lid matching the fryer body such that the electronic thermometer can perform real time temperature monitoring by the temperature insertion pin directly inserted into the fryer body and realize cutoff control for the gas passage of the stove body by the gas disconnecting piece in communication with the electronic thermometer. In this way, an effective and stable temperature control effect can be achieved and thus, the wireless temperature control turkey fryer has the effects of use conveniences and significantly-increased temperature control effectiveness.

### BRIEF DESCRIPTIONS OF THE DRAWINGS

FIG. 1 is a structural schematic diagram of an embodiment of the present invention.

FIG. 2 is a structural schematic diagram of another angle of an embodiment of the present invention.

Numerals of the drawings are described below: 1. outer fryer body, 2. inner fryer body, 3. fryer lid, 4. electronic thermometer, 41. temperature insertion pin, 5. outer ring seat, 51. support leg, 52. heat insulation sheet, 53. stove rack sheet metal piece, 54. annular wind barrier, 6. control panel, 61. gas disconnecting assembly, 62. needle valve, 7. stove body, 71. stove, 72. lifting bolt.

### DETAILED DESCRIPTIONS OF EMBODIMENTS

In order to make the technical solutions and the advantages of the present invention clearer, detailed descriptions will be made further to the present invention in combination with the accompanying drawings. Apparently, the embodiments described herein are only some embodiments of the present invention rather than all embodiments. All other embodiments obtained by those skilled in the art based on these embodiments without making creative work shall all fall within the scope of protection of the present invention.

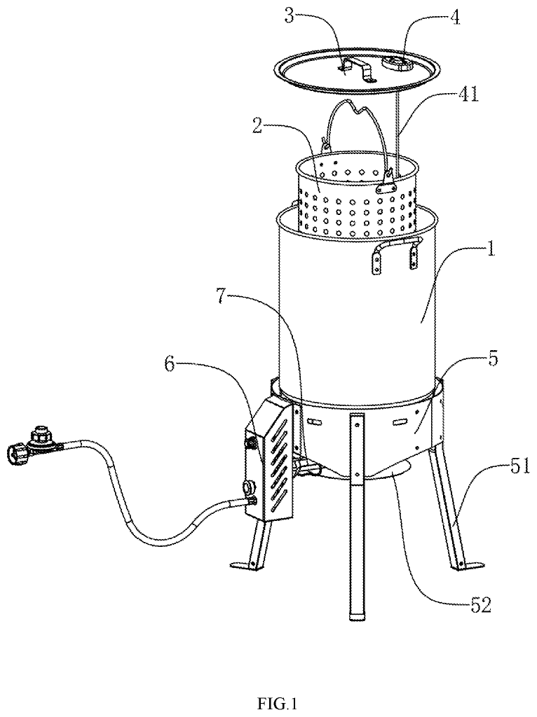

As shown in FIG. 1, there is provided a wireless temperature control turkey fryer, comprising a fryer body, a fryer lid 3 matching the fryer body and an outer ring seat 5 for supporting the fryer body. The fryer body consists of an outer fryer body 1 and an inner fryer body 2. The fryer lid 3 matches a top opening of the outer fryer body 1. The inner fryer body 2 can hold food materials for cooking and be directly placed into the outer fryer body 1. In this way, the use difficulty of the wireless temperature control turkey fryer can be greatly reduced.

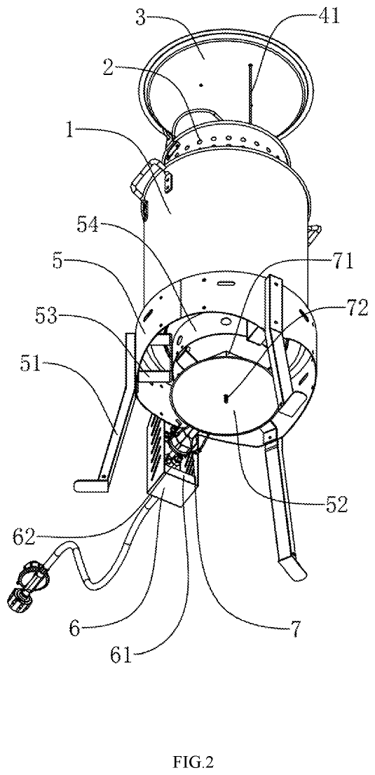

As shown in FIGS. 1 and 2, a stove body 7 for heating the bottom of the fryer body is disposed inside the outer ring seat 5. The stove body 7 is provided with a gas disconnecting piece for cutting off a gas passage. Further, an electronic thermometer 4 is disposed on the fryer lid 3. The electronic thermometer 4 is provided with a temperature insertion pin 41 inserted into the fryer body for temperature monitoring. The temperature insertion pin 41 communicates with the gas disconnecting piece in the form of Bluetooth or video or the like, such that the gas disconnecting piece is enabled to start and cut off the gas passage at the time of a temperature in the fryer body exceeding a set threshold. Therefore, the stove body 7 inside the outer ring seat 5 can heat the bottom of the fryer body for the purpose of cooking. Further, when the fryer lid 3 and the fryer body are cooperatively fixed, the electronic thermometer 41 fixed on the fryer lid 3 can perform temperature monitoring by the temperature insertion pin 41 directly inserted into the fryer body, bringing use conveniences and increased temperature control effectiveness; at the same time, when the temperature in the fryer body exceeds the set threshold, the gas disconnecting piece can be enabled to start and cut off the gas passage, achieving temperature control effect.

It is to be noted that the electronic thermometer 4 is provided with a buzzer for giving warning at the time of the temperature in the fryer body exceeding the set threshold. Thus, the buzzer can give effective warning in time to help a user to realize effective cooking for food materials, thus significantly improving the use convenience of the wireless temperature control turkey fryer.

As shown in FIG. 2, a plurality of support legs 51 distributed in a same radian on an outer circumferential side of the outer ring seat 5, and a plurality of U-shaped stove rack sheet metal pieces 53 distributed in a same radian on an inner side of the outer ring seat 5. Both ends of the stove rack sheet metal piece 53 are fixedly connected to the outer ring seat 5, and the bottom of the outer fryer body 1 is abutted against the stove rack sheet metal pieces 53. Therefore, the stove rack sheet metal pieces can effectively support and fix the fryer body so as to achieve the effect of placing the fryer body easily. The support legs 51 can stably support the outer ring seat 5 so as to achieve the purpose of stable cooking.

It is noted that the gas disconnecting piece comprises a control panel 6 which is provided with a gas disconnecting assembly 61 in communication connection with the electronic thermometer 4 and a needle valve 62 in communication with the stove body 7. When the gas disconnecting assembly 61 receives a real-time monitored temperature of the electronic thermometer 4, the gas passage of the stove body 7 can be cut off by controlling the needle valve 62 to be off, thus realizing temperature control. In this way, the wireless temperature control turkey fryer has the effects of use conveniences and significantly-increased temperature control effectiveness.

As shown in FIG. 2, an annular wind barrier 54 is fixedly mounted at inner sides of the plurality of stove rack sheet metal pieces 53. The stove body 7 is provided with a stove 71 for producing combustion flame, and the annular wind barrier 54 is sleeved on the stove 71. Further, through holes are disposed on both of the annular wind barrier 54 and the outer ring seat 5. The annular wind barrier 54 can effectively keep out wind and prevent environmental influence, and the through holes are used for the gas to carry oxygen into the stove 71 so as to realize stable gas combustion effect. It is noted that the stove 71 is provided with a lifting bolt 72 inserted from top down and the lifting bolt 72 is thread-connected with a heat insulation sheet 52 located at a lower end of the stove 71. The heat insulation sheet 52 can perform bottom heat insulation and can be adjusted by rotation for a distance between the heat insulation sheet 52 and the stove 71 so as to reduce the operation difficulty and improve use convenience.

To sum up, in the present invention, the electronic thermometer 4 is disposed on the fryer lid 3 matching the fryer body such that the electronic thermometer 4 can perform real time temperature monitoring by the temperature insertion pin 41 directly inserted into the fryer body and realize cutoff control for the gas passage of the stove body 7 by the gas disconnecting piece in communication with the electronic thermometer 4. In this way, an effective and stable temperature control effect can be achieved and thus, the wireless temperature control turkey fryer has the effects of use conveniences and significantly-increased temperature control effectiveness.

The terms such as “first”, “second”, “third” and “fourth” (if present) involved in the present invention are used to distinguish similar objects rather than describe a specific sequence or precedence. It should be understood that the data used this way can be exchanged in proper cases such that the embodiments described herein can be implemented in an order other than the sequences illustrated or described herein. Furthermore, the terms “including” and “having” and their variations are intended to cover non-exclusive inclusion, for example, processes, methods or devices including a series of steps or units are not necessarily limited to those steps or units clearly listed, but may include other steps or units not listed herein or inherent to these processes, methods and devices.

It is noted that the descriptions involving “first” and “second” etc. in the present invention are used only for the purpose of descriptions and shall not be understood as indicating or implying relative importance or implicitly indicating a number of the indicated technical features. Thus, the features limited by “first” and “second” etc. may explicitly or implicitly include at least one of these features. In addition, the technical solutions of various embodiments can be combined mutually as long as such combinations can be implemented by those skilled in the arts. When the combinations of the technical solutions have contradictions or cannot be implemented, it should be deemed that the combinations of the technical solutions are not existent nor within in the scope of protection of the present invention.

The principle and implementations of the present invention are elaborated with specific embodiments and the above descriptions for the embodiments are used only to help understand the method and core idea of the present invention. Furthermore, persons of ordinary skill in the art may make changes to the specific implementations and the application scope based on the idea of the present invention. In conclusion, the contents of the specification shall not be understood as limiting of the present invention.

What is claimed is:

1. A wireless temperature control turkey fryer, comprising a fryer body, a fryer lid (3) matching the fryer body and an outer ring seat (5) supporting the fryer body; a stove body (7) for heating the bottom of the fryer body is disposed inside the outer ring seat (5); wherein the stove body (7) is provided with a gas disconnecting piece for cutting off a gas passage; the fryer lid (3) is provided with an electronic thermometer (4), and the electronic thermometer (4) is provided with a temperature insertion pin (41) for being inserted into the fryer body for temperature monitoring; the temperature insertion pin (41) is in communication connection with the gas disconnecting piece such that the gas disconnecting piece is enabled to start and cut off the gas passage when a temperature in the fryer body exceeds a set threshold.

2. The wireless temperature control turkey fryer of claim 1, wherein the electronic thermometer (4) is provided with a buzzer for giving warning at the time of the temperature in the fryer body exceeding the set threshold.

3. The wireless temperature control turkey fryer of claim 1, wherein a plurality of support legs (51) distributed in a same radian on an outer circumferential side of the outer ring seat (5), and a plurality of U-shaped stove rack sheet metal pieces (53) distributed in a same radian on an inner side of the outer ring seat (5); both ends of the stove rack sheet metal piece (53) are fixedly connected to the outer ring seat (5), and the bottom of the fryer body is abutted against the stove rack sheet metal pieces (53).

4. The wireless temperature control turkey fryer of claim 3, wherein the gas disconnecting piece comprises a control panel (6), and the control panel (6) is provided with a gas disconnecting assembly (61) in communication connection with the electronic thermometer (4) and a needle valve (62) in communication with the stove body (7).

5. The wireless temperature control turkey fryer of claim 4, wherein an annular wind barrier (54) is fixedly mounted at inner sides of the plurality of stove rack sheet metal pieces (53), and the stove body (7) is provided with a stove (71) for producing combustion flame; the annular wind barrier (54) is disposed on the stove (71), and through holes are disposed on both of the annular wind barrier (54) and the outer ring seat (5).

6. The wireless temperature control turkey fryer of claim 5, wherein the stove (71) is provided with a lifting bolt (72) inserted from top down and the lifting bolt (72) is thread-connected with a heat insulation sheet (52) located at a lower end of the stove (71).
